(19) United States
(12) Patent Application Publication
(10) Pub. No.: US 2022/0268589 A1
(43) Pub. Date: Aug. 25, 2022

(54) ROUTE SEARCH SYSTEM, ROUTE SEARCH APPARATUS, AND COMPUTER READABLE RECORDING MEDIUM

(71) Applicant: TOYOTA JIDOSHA KABUSHIKI KAISHA, Toyota-shi (JP)

(72) Inventors: Yu NAGATA, Tokyo-to (JP); Seii SAI, Yokohama-shi (JP); Akane HAMADA, Tokyo-to (JP)

(21) Appl. No.: 17/585,927

(22) Filed: Jan. 27, 2022

(30) Foreign Application Priority Data
Feb. 25, 2021 (JP) 2021-028993

(51) Int. Cl. G01C 21/34; G01C 21/36

(52) U.S. Cl. CPC G01C 21/3423; G01C 21/3691; G01C 21/362; G01C 21/3697

(57) ABSTRACT

A route search system includes: a center server configured to perform a route search using preset transportation; a weather server configured to output weather information to the center server; and a terminal device configured to output, to the center server, a route search request including at least a scheduled departure time, an origin, and a destination. The center server is configured to: acquire the weather information along a route from the origin to the destination from the weather server in a case where the route search request is acquired from the terminal device; perform the route search in consideration of weather along the route included in the weather information; and output, to the terminal device, a route search result including at least the scheduled departure time, the origin, the destination, transportation used along the route, a boarding point of the transportation, and an exit point of the transportation.

The present application claims priority to and incorporates by reference the entire contents of Japanese Patent Application No. 2021-028993 filed in Japan on Feb. 25, 2021.

### BACKGROUND

The present disclosure relates to a route search system, a route search apparatus, and a computer readable recording medium.

There is known a multimodal route search which is a route search performed by combining a plurality of transportation (refer to JP 2020-071107 A, for example).

### SUMMARY

In the multimodal route search, there is a need for a technique capable of suggesting a route using an optimum transportation in accordance with weather along the route.

According to one aspect of the present disclosure, there is provided a route search system including: a center server including a first processor configured to perform a route search using one or a combination of a plurality types of preset transportation; a weather server including a second processor configured to output weather information to the center server; and a terminal device including a third processor configured to output, to the center server, a route search request including at least a scheduled departure time, an origin, and a destination, wherein the first processor is configured to: acquire the weather information along a route from the origin to the destination from the weather server in a case where the route search request is acquired from the terminal device; perform the route search in consideration of weather along the route included in the weather information; and output, to the terminal device, a route search result including at least the scheduled departure time, the origin, the destination, transportation used along the route, a boarding point of the transportation, and an exit point of the transportation.

### BRIEF DESCRIPTION OF THE DRAWINGS

FIG. 1 is a schematic diagram illustrating an overall configuration of a route search;

FIG. 2 is a block diagram illustrating details of individual components of a route search system;

FIG. 3 is a view illustrating an example of an input screen of a route search condition to be displayed on a terminal device in a route search system;

FIG. 4 is a view illustrating an example of a display screen of a route search result to be displayed on a terminal device in a route search system;

FIG. 5 is a view illustrating an example of a display screen of a route search result to be displayed on a terminal device when the weather along the route is rainy in a route search system;

FIG. 6 is a flowchart illustrating an example of a case where a route search is performed based on a user's request in a route search method executed by a route search system; and

FIG. 7 is a flowchart illustrating an example of a case where a route search is initially performed based on a user's request and thereafter a route search is performed again based on weather information in a route search method executed by a route search system.

### DETAILED DESCRIPTION

A route search system, a route search apparatus, and a computer readable recording medium storing a route search program according to an embodiment will be described with reference to the drawings. Note that the constituent elements in the following embodiment include those that are easily replaceable by those skilled in the art, or those that are substantially the same.

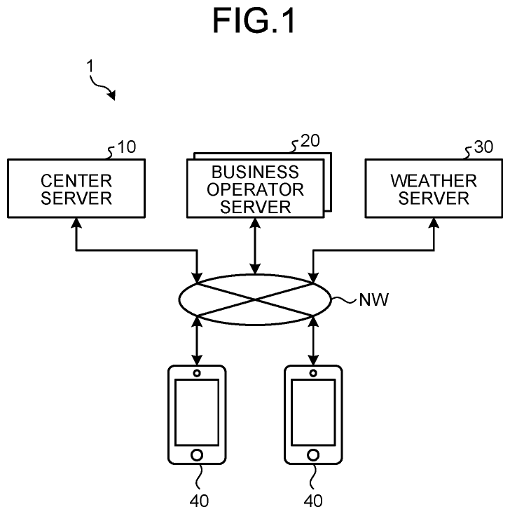

A route search system including a route search apparatus according to the embodiment will be described with reference to FIGS. 1 to 5. As illustrated in FIG. 1, a route search system 1 includes a center server 10, a plurality of business operator servers 20, a weather server 30, and a plurality of terminal devices 40. The route search apparatus according to the embodiment is implemented by the function of the center server 10 of the route search system 1. The center server 10, the business operator server 20, the weather server 30, and the terminal device 40 all have a communication function so as to be communicable with each other through a network NW. The network NW is composed of, for example, an Internet network, a mobile phone network, or the like.

The center server 10 is a server provided for performing a multimodal route search from an origin to a destination using one or a combination of two or more of a plurality of preset transportation such as an automobile, walking, cycling, and public transportations. The center server 10 is implemented by a general-purpose computer such as a workstation or a personal computer, for example.

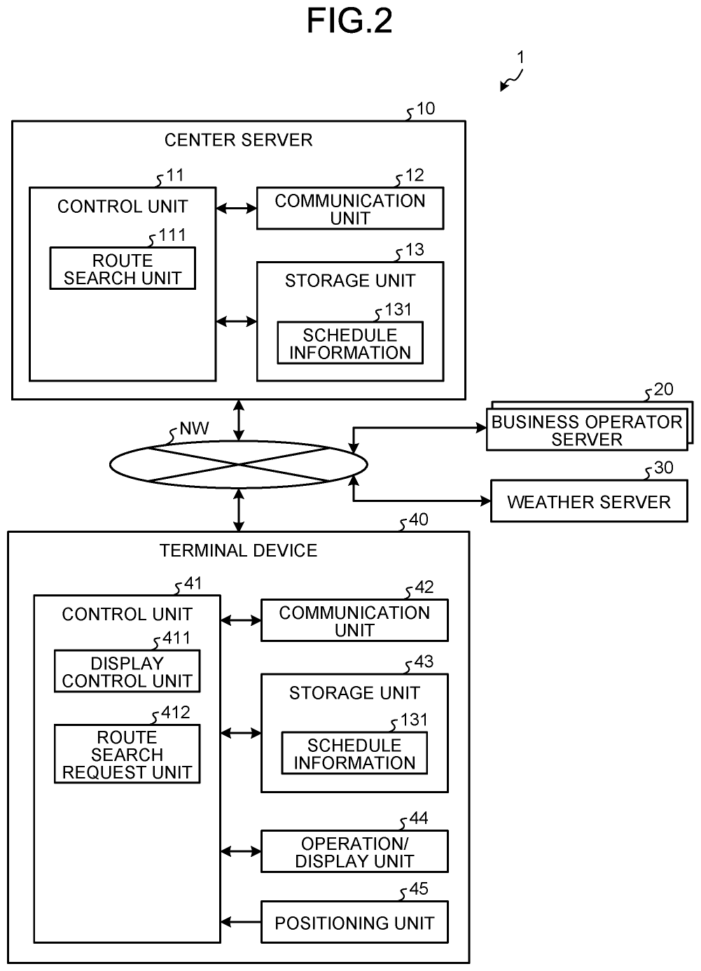

As illustrated in FIG. 2, the center server 10 includes a control unit 11, a communication unit 12, and a storage unit 13. The control unit 11 is specifically equipped with: a processor including a central processing unit (CPU), a digital signal processor (DSP), a field-programmable gate array (FPGA), or a graphics processing unit (GPU); and a memory (main storage unit) including random access memory (RAM) and read only memory (ROM).

The control unit 11 loads a program stored in the storage unit 13 into the work area of the main storage unit and executes the program. Through execution of the program, the control unit 11 controls individual components, thereby actualizing a function that matches a predetermined purpose. The control unit 11 functions as a route search unit 111 through execution of a program stored in the storage unit 13.

The route search unit 111 communicates with a plurality of business operator servers 20 based on a route search request acquired from the terminal device 40, and performs a multimodal route search combining a plurality types of transportation by this communication. Subsequently, the route search unit 111 registers (stores) a result of the route search (hereinafter, referred to as a “route search result”) in the storage unit 13 as schedule information 131.

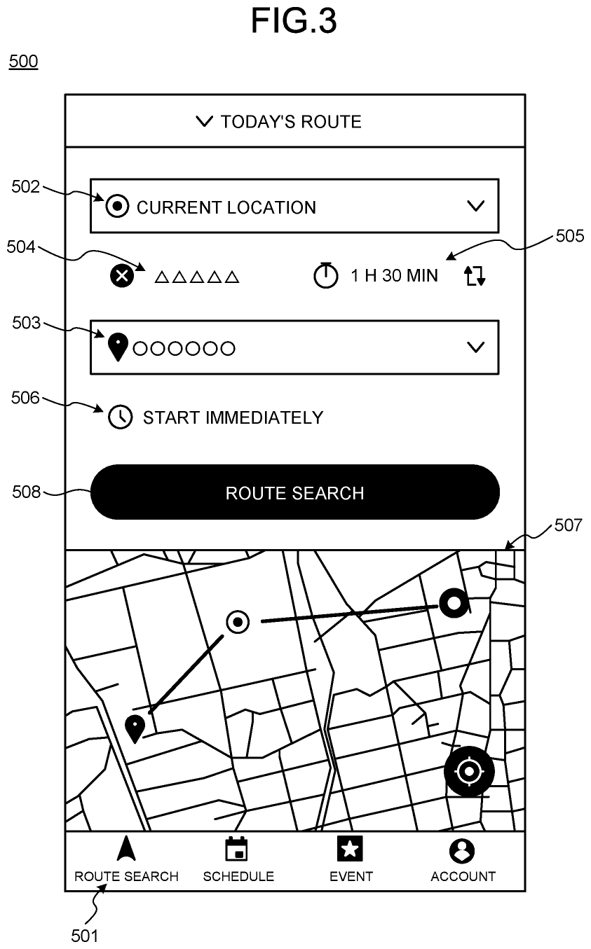

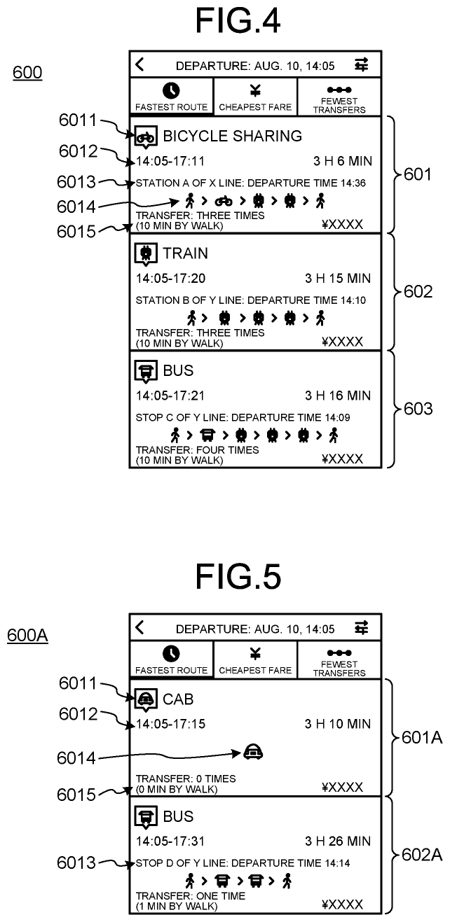

Here, FIG. 3 illustrates an example of an input screen 500 of the route search condition to be displayed on an operation/display unit 44 of the terminal device 40 when the route search unit 111 searches for a route. FIG. 4 illustrates an example of a display screen 600 of the route search result to be displayed on the operation/display unit 44 of the terminal device 40 when the route search unit 111 searches for a route.

The input screen 500 in FIG. 3 is displayed on the operation/display unit 44, for example, by pressing a route search button 501 in the lowermost menu of FIG. 3 (for example, by performing a touch operation on a corresponding position of the operation/display unit 44) in a route search application installed in the terminal device 40. The input screen 500 includes an origin box 502, a destination box 503, a waypoint box 504, a stay time setting menu 505, a departure time setting menu 506, a map display region 507, and a route search execution button 508.

The origin box 502 is provided for setting an origin in the multimodal route search. The origin box 502 has, as default setting, the settings of the current position of the terminal device 40 detected by a positioning unit 45 of the terminal device 40, for example.

The destination box 503 is provided for setting a destination in the multimodal route search. The waypoint box 504 is provided for setting a waypoint in the multimodal route search. The stay time setting menu 505 is provided for setting a stay time at the waypoint in the multimodal route search. The departure time setting menu 506 is provided for setting a departure time from the origin in the multimodal route search.

The map display region 507 is a region to display a map image of an area including the origin, the destination, and the waypoint set in the origin box 502, the destination box 503, and the waypoint box 504. The route search execution button 508 is provided for causing the route search unit 111 to execute the multimodal route search in accordance with the settings made to the origin box 502, the destination box 503, the waypoint box 504, the stay time setting menu 505, and the departure time setting menu 506. When the user presses the route search execution button 508, a route search request is transmitted from the terminal device 40 to the center server 10. Subsequently, the route search unit 111 performs a route search based on the route search request.

Note that the route search request output from the terminal device 40 to the center server 10 includes at least information regarding the scheduled departure time, the origin, and the destination. The route search request further includes a route search condition, information regarding the current location of the user, and information regarding the waypoint on a way from the origin to the destination, as necessary.

After the route search execution button 508 is pressed by the user on the input screen 500 of FIG. 3, the route search result is transmitted from the route search unit 111 to the terminal device 40, and then, the screen transitions to the display screen 600 illustrated in FIG. 4. The display screen 600 displays route candidate display regions 601 to 603 corresponding to a plurality of route candidates.

The route candidate display regions 601 to 603 include, for example, a display field 6011 that displays representative transportation included in the route candidate, a display field 6012 that displays a traveling time, a display field 6013 that displays a boarding station and an exit station of a public transportation, a display field 6014 that displays a symbol of each type of transportation, a display field 6015 that displays the number of times of transfer and a walking time, and the like.

Here, the route search unit 111 performs a route search based on a plurality types of preset transportation and weather along the route. That is, when having acquired a route search request from the terminal device 40 via the network NW, the route search unit 111 outputs a request for weather information (hereinafter, referred to as “weather information request”) to the weather server 30. With this configuration, the route search unit 111 acquires, from the weather server 30, weather information along the route from the origin to the destination included in the route search request acquired from the terminal device 40.

Subsequently, the route search unit 111 performs a route search in consideration of the weather along the route included in the weather information acquired from the weather server 30. When the weather along the route is other than rainy, that is, when it is sunny or cloudy, the route search unit 111 performs a route search including the transportation involving a possibility of getting wet in rain. Note that examples of the “transportation involving a possibility of getting wet in rain” include a transportation such as automobile bicycle and walking, which has no rain blocking means. In this case, the route search unit 111 searches for a route using the transportation such as bicycle sharing or walking as illustrated in the route candidate display regions 601 to 603 in FIG. 4, for example.

In contrast, when the weather along the route is rainy, the route search unit 111 performs a route search excluding the transportation involving a possibility of getting wet in rain. In this case, the route search unit 111 searches for a route using transportation such as a cab or a private car as illustrated in a route candidate display region 601A in FIG. 5, for example.

Subsequently, the route search unit 111 outputs a route search result as illustrated in FIG. 4 or 5 to the terminal device 40 that is a source of the route search request (route search request source). In addition, the route search unit 111 registers the route search result in the storage unit 13 as the schedule information 131 of the user, and outputs the schedule information 131 to the terminal device 40 as the route search request source.

In this manner, the route search system 1 performs a route search in consideration of the weather along the route in addition to the plurality types of transportation, making it possible to suggest to the user the optimum transportation in accordance with the weather. For example, in a case where the weather along the route is rainy, it is possible to preferentially search for a route that does not use the transportation such as a bicycle or walking which involves a possibility of getting wet in rain, and possible to suggest the route to the user.

In addition, for example, before the user uses a route obtained by the search in the past, that is, before the scheduled departure time of the user on the route, the route search unit 111 may perform a route search again based on weather information and may suggest a route search result to the user's terminal device 40.

In this case, the route search unit 111 loads the schedule information 131 before the scheduled departure time of the user, and then determines whether the route search result includes a route using the transportation (for example, a bicycle, walking, or the like) involving a possibility of getting wet in rain. When having determined that the route search result includes a route using the transportation involving a possibility of getting wet in rain, the route search unit 111 outputs a weather information request, which is a request for obtaining weather information along the route, to the weather server 30, and then acquires the weather information from the weather server 30.

Subsequently, when the weather along the route included in the acquired weather information is rainy, the route search unit 111 performs a route search again excluding the transportation involving a possibility of getting wet in rain, and then outputs a route search result (that is, a result of an alternative route search) and weather information to the terminal device 40. In addition, the route search unit 111 registers the route search result in the storage unit 13 as the schedule information 131 of the user, and outputs the schedule information 131 to the terminal device 40 as the route search request source.

In this manner, in the route search system 1, after the route search based on the user's request, the center server 10 performs a route search again in consideration of the weather along the route, making it possible to suggest to the user the optimum transportation in accordance with the latest weather. For example, in a case where the latest weather along the route is rainy, it is possible to search again for a route that does not include the transportation such as a bicycle or walking which involves a possibility of getting wet in rain, and possible to suggest the route to the user.

In addition, when the weather along the route is rainy, the route search unit 111 may search for a route to a point as close as possible to the final destination. In this case, when having acquired a route search request from the terminal device 40, the route search unit 111 outputs a weather information request to the weather server 30 and acquires weather information.

Subsequently, when the weather along the route included in the acquired weather information is rainy, the route search unit 111 performs a route search such that the final exit point of the transportation included in the route search result will be the exit point closest to the destination, and outputs a result of the route search and the weather information to the terminal device 40. In addition, the route search unit 111 registers the route search result in the storage unit 13 as the schedule information 131 of the user, and outputs the schedule information 131 to the terminal device 40 as the route search request source.

For example, when the weather along the route is other than rainy, the route search unit 111 suggests a route candidate in which the final exit point is “stop C” as illustrated in the route candidate display region 603 of the display screen 600 in FIG. 4. This stop C is, for example, an exit point slightly away from the final destination. In contrast, when the weather along the route is rainy, the route search unit 111 suggests a route candidate in which the final exit point is “stop D” as illustrated in a route candidate display region 602A of a display screen 600A in FIG. 5. This stop D is an exit point closest to the final destination, for example. In addition, even with the estimation that the arrival time of the route candidate indicated in the route candidate display region 602A will be later by 10 minutes than the arrival time of the route candidate indicated in the route candidate display region 603, the route search unit 111 performs, when the weather along the route is rainy, a route search with priority on a shortness of the distance from the final exit point to the final destination over the arrival time.

In this manner, the route search system 1 performs a route search such that the final exit point of the transportation included in the route search result will be the exit point closest to the destination, making it possible to suggest to the user a route by which the user can travel to the destination avoiding the rain.

Alternatively, when the weather along the route is rainy, the route search unit 111 may search for a route to a roofed facility. In this case, when having acquired a route search request from the terminal device 40, the route search unit 111 outputs a weather information request to the weather server 30 and acquires weather information.

Subsequently, when the weather along the route included in the acquired weather information is rainy, the route search unit 111 performs a route search such that the final exit point of the transportation included in the route search result will be the roofed facility, and outputs a result of the route search and the weather information to the terminal device 40. In addition, the route search unit 111 registers the route search result in the storage unit 13 as the schedule information 131 of the user, and outputs the schedule information 131 to the terminal device 40 as the route search request source.

Here, when the weather along the route is other than rainy, the route search unit 111 suggests a route candidate in which the final exit point is “stop C”, for example, as illustrated in the route candidate display region 603 in FIG. 4. This stop C is for example a roofless stop. In contrast, when the weather along the route is rainy, the route search unit 111 suggests a route candidate in which the final exit point is “stop D”, for example, as illustrated in the route candidate display region 602A in FIG. 5. This stop D is a roofed stop, for example. In addition, even with the estimation that the arrival time of the route candidate indicated in the route candidate display region 602A will be later by 10 minutes than the arrival time of the route candidate indicated in the route candidate display region 603, the route search unit 111 performs, when the weather along the route is rainy, a route search with priority on the presence or absence of a roof at the stop of the final exit point over the arrival time.

In this manner, the route search system 1 performs a route search such that the final exit point of the transportation included in the route search result will be the roofed facility, making it possible to suggest to the user a route by which the user can travel to the destination avoiding the rain.

The communication unit 12 is constituted with, for example, a local area network (LAN) interface board, a wireless communication circuit for wireless communication, or the like. The communication unit 12 is connected to the network NW such as the Internet which is a public communication network. The communication unit 12 communicates with the business operator server 20, the weather server 30, and the terminal device 40 by connecting to the network NW.

The storage unit 13 includes a recording medium such as erasable programmable ROM (EPROM), a hard disk drive (HDD), and a removable medium. Examples of the removable medium include disc recording media such as a universal serial bus (USB) flash drive, a compact disc (CD), a digital versatile disc (DVD), and a Blu-ray (registered trademark) disc (BD). The storage unit 13 can store an operating system (OS), various programs, various tables, various databases, or the like.

The storage unit 13 stores the schedule information 131. The schedule information 131 is information indicating a result of past route search performed by the route search unit 111. The schedule information 131 is stored in the storage unit 13 for each of users (terminal devices 40). The schedule information 131 includes at least information regarding a scheduled departure time, an origin, a destination, transportation used along the route, a boarding point of the transportation, and an exit point of the transportation. The schedule information 131 further includes a route search condition, information regarding the current location of the user at the time of the route search, and information regarding the waypoint on a way from the origin to the destination, as necessary. In addition, the schedule information 131 is output from the center server 10 to the terminal device 40 at the timing when the route search by the route search unit 111 is completed.

The business operator server 20 is a server managed by a business operator that provides transportation used for multimodal route search. The business operator server 20 is implemented by a general-purpose computer such as a workstation or a personal computer, for example.

Examples of the server constituting the business operator server 20 include a route bus related server, a railway related server, a highway bus related server, an aviation related server, a ship related server, a cab related server, a ridesharing related server, a car sharing related server, a rental car related server, a bicycle sharing related server, and the like.

The route bus related server is operated by an operating company of a route bus or the like, and provides the center server 10 with information regarding the operation of the route bus or the like (for example, a timetable, an operation status including a delay, a current position of each vehicle, and the like). The railway related server is operated by an operating company of a railway or the like, and provides the center server 10 with information regarding the operation of the railway or the like (for example, a timetable, an operation status including a delay, a vacant seat status of each of reservable trains, and the like). The highway bus related server is operated by an operating company of a highway bus or the like, and provides the center server 10 with information regarding the operation of the highway bus or the like (for example, a timetable, an operation status including a delay, a vacant seat status of each vehicle, and the like). The aviation related server is operated by an operating company of an airplane or the like, and provides the center server 10 with information regarding the operation of the airplane or the like (for example, a timetable, an operation status including a delay, a vacant seat status of each service, and the like).

The ship related server is operated by an operating company of a ship or the like, and provides the center server 10 with information regarding the operation of the ship or the like (for example, a timetable, an operation status including a delay, a vacant seat status of each reservable service, and the like). The cab related server is operated by a cab service provider or the like, and provides the center server 10 with various types of cab service related information (for example, position information of each vehicle, an operation status including a vacant/in service with a passenger, and the like). The ridesharing related server is operated by a ridesharing service provider or the like, and provides the center server 10 with various types of ridesharing related information (for example, a current position of each vehicle operating in the ridesharing, availability of vehicles, and the like). The car sharing related server is operated by a service provider of car sharing, or the like, and provides the center server 10 with various types of car sharing service related information (for example, the number of parking spaces of each station that provides cars for sharing, the number of vehicles currently available, the number of vehicles ready to be returned, and the like).

The rental car related server is operated by a rental car service provider or the like, and provides the center server 10 with various types of rental car service related information (for example, the types of vehicles ready for rental at each office that provides rental cars, the number of vehicles currently ready for each type of vehicle in each office, and the like). Furthermore, the bicycle sharing related server is operated by a bicycle sharing service provider or the like, and provides the center server 10 with various types of bicycle sharing service related information (for example, the number of bicycles that can be provided or the current number of vacant bicycles for each of the plurality of bicycle ports that provide the bicycle sharing). In this manner, the center server 10 performs the multimodal route search based on the information provided from each of servers constituting the business operator server 20.

The weather server 30 is a server managed by an organization that collects and provides weather information, such as the Meteorological Agency. When having acquired a weather information request from the center server 10, the weather server 30 outputs weather information along the route included in the weather information request to the center server 10. The weather server 30 is implemented by a general-purpose computer such as a workstation or a personal computer, for example. Furthermore, the weather information provided by the weather server 30 includes, for example, future weather (for example, precipitation probability or the like), temperature, humidity, wind speed, and the like.

The terminal device 40 outputs a route search request to the center server 10 based on a user's operation. The terminal device 40 is implemented by a smartphone, a mobile phone, a tablet terminal device, a wearable computer, or the like owned by the user, for example.

As illustrated in FIG. 2, the terminal device 40 includes a control unit 41, a communication unit 42, a storage unit 43, an operation/display unit 44, and a positioning unit 45. The control unit 41 functions as a display control unit 411 and a route search request unit 412 through execution of a program stored in the storage unit 43.

The display control unit 411 controls the display on the operation/display unit 44. The display control unit 411 controls the operation/display unit 44 to display the input screen 500 of the route search condition (refer to FIG. 3) and the display screens 600 and 600A to display route search results (refer to FIGS. 4 and 5), for example.

The route search request unit 412 transmits a route search request to the center server 10 in response to the user's operation. Specifically, when the user has pressed the route search execution button 508 on the input screen 500 of the route search condition (refer to FIG. 3), the route search request unit 412 transmits a route search request based on the input to the center server 10. In addition, the route search request includes at least information regarding the scheduled departure time, the origin, and the destination, and further includes a route search condition, information regarding the current location of the user, and information regarding the waypoint as necessary.

The communication unit 42 communicates with the center server 10 by wireless communication via the network NW. The storage unit 43 stores the schedule information 131 acquired from the center server 10.

The operation/display unit 44 is constituted with a touch panel display or the like, for example, and includes an input function of receiving an operation by a user's finger, a pen, or the like, and a display function of displaying various types of information under the control of the display control unit 411. Under the control of the display control unit 411, the operation/display unit 44 displays the input screen 500 of the route search condition (refer to FIG. 3), the display screens 600 and 600A to display route search results (refer to FIGS. 4 and 5) and the like.

The positioning unit 45 receives a radio wave from a global positioning system (GPS) satellite, and detects information regarding a current position of the terminal device 40 (hereinafter, referred to as “position information”). The method of detecting the position information is not limited to the method using the GPS satellite. For example, it is allowable to use a method combining light detection and ranging, laser imaging detection and ranging (LiDAR) and a three-dimensional digital map. The positioning unit 45 outputs the detected position information to the control unit 41.

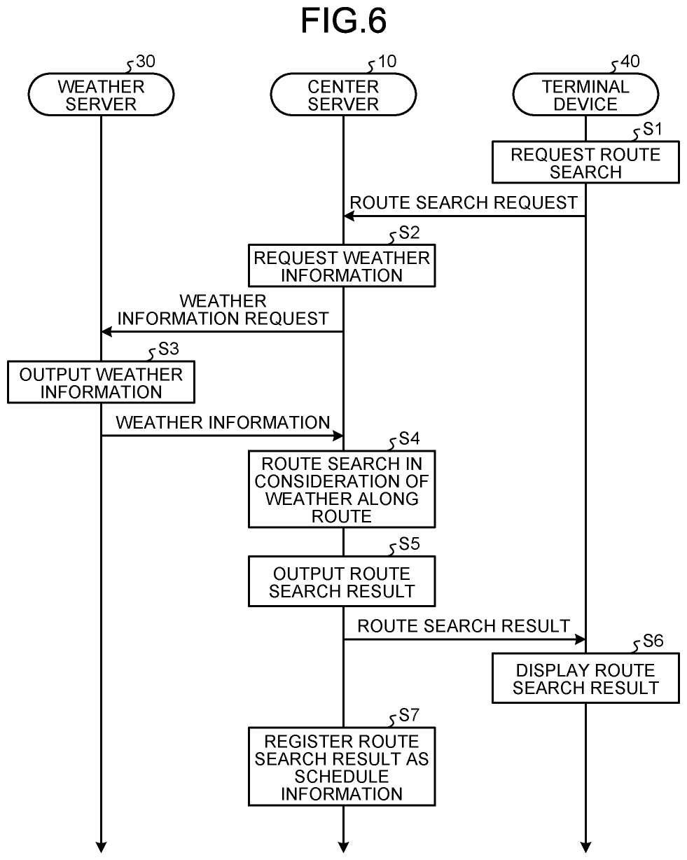

A first example of a processing procedure of a route search method executed by the route search system 1 according to the embodiment will be described with reference to FIG. 6. The drawing illustrates an example of a case where a route search is performed based on a user's request.

First, the route search request unit 412 of the terminal device 40 outputs a route search request to the center server 10 based on the user's input on the input screen 500 of the route search condition (refer to FIG. 3) (step S1). Subsequently, the route search unit 111 of the center server 10 outputs a weather information request to the weather server 30 (step S2).

Subsequently, the weather server 30 outputs weather information along the route from the origin to the destination included in the route search request to the center server 10 (step S3). Subsequently, the route search unit 111 performs a route search in consideration of the weather along the route included in the weather information (step S4), and outputs a result of the route search to the terminal device 40 (step S5).

Subsequently, the display control unit 411 displays the route search result on the operation/display unit 44 (step S6). Subsequently, the route search unit 111 registers the route search result in the storage unit 13 as the schedule information 131 (step S7). This completes the present process.

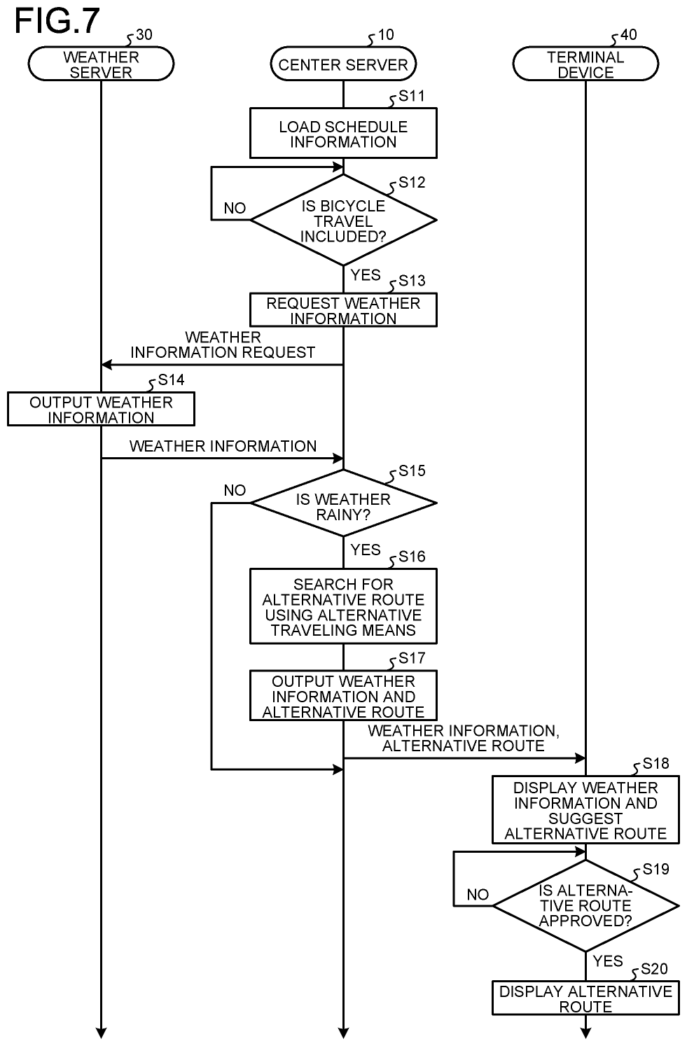

A second example of the processing procedure of the route search method executed by the route search system 1 according to the embodiment will be described with reference to FIG. 7. The drawing illustrates an exemplary case where the center server 10 performs a route search again based on weather information after performing a route search based on a user's request.

First, the route search unit 111 loads the schedule information 131 from the storage unit 13 (step S11). Subsequently, the route search unit 111 determines whether the route search result of the schedule information 131 includes bicycle travel (that is, a travel using the transportation involving a possibility of getting wet in rain) (step S12).

When having determined that the route search result of the schedule information 131 includes bicycle travel (Yes in step S12), the route search unit 111 outputs a weather information request to the weather server 30 (step S13). When having determined that the route search result of the schedule information 131 does not include the bicycle travel (No in step S12), the route search unit 111 returns to the determination of step S12.

Subsequently, the weather server 30 outputs weather information along the route from the origin to the destination included in the route search request to the center server 10 (step S14). Subsequently, the route search unit 111 determines whether the weather along the route included in the acquired weather information is rainy (step S15).

When having determined that the weather along the route is rainy (Yes in step S15), the route search unit 111 searches for an alternative route using alternative transportation, that is, transportation that does not involve a possibility of getting wet in rain (step S16). When having determined that the weather along the route is not rainy (No in step S15), the route search unit 111 completes the present process.

Subsequently, the route search unit 111 outputs the weather information and the search result of the alternative route to the terminal device 40 (step S17). Subsequently, the display control unit 411 displays the weather information on the operation/display unit 44 and suggests the alternative route to the user (step S18). Note that alternative route suggesting methods in step S18 include, for example, displaying, by the display control unit 411, a message such as “Display alternative route?”, or displaying an approval button, a disapproval button, and the like on the operation/display unit 44.

Subsequently, the display control unit 411 determines whether the user has approved the alternative route (step S19). For example, step S19 makes an affirmative determination in a case where the user has pressed (by touch operation, for example) an approval button displayed on the operation/display unit 44, or makes a negative determination in a case where the user has pressed (by touch operation, for example) a disapproval button displayed on the operation/display unit 44.

When having determined in step S19 that the user has approved the alternative route (Yes in step S19), the display control unit 411 displays search results of the alternative route on the operation/display unit 44 (step S20). When having determined in step S19 that the user has not approved the alternative route (No in step S19), the display control unit 411 returns to the determination in step S19. This completes the present process.

As described above, according to the route search system, the route search apparatus, and the route search program according to the embodiment, it is possible to suggest a route using the optimum transportation in accordance with the weather along the route in the multimodal route search.

Further effects and modifications can be easily derived by those skilled in the art. Accordingly, broader aspects of the present invention are not to be limited to the particular details and representative embodiment illustrated and described above. Accordingly, various alterations and modifications may be made without departing from the spirit or scope of the general inventive concept as defined by the appended claims and their equivalents.

For example, the route search system 1 searches for a route that preferentially uses the transportation that does not involve a possibility of getting wet in rain when the weather along the route is rainy. However, in a case where the weather along the route is snowy, hailing with big particles, hailing with small particles, dense fog, stormy/heavily windy, or the like, the route search system 1 may also search for a route that preferentially uses atransportation (a cab, a private car, a bus, a train, etc.) that can avoid these weathers in addition to rainy.

According to the present disclosure, it is possible, in a multimodal route search, to suggest a route using optimum transportation in accordance with weather along the route.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A route search system comprising:
a center server comprising a first processor configured to perform a route search using one or a combination of a plurality types of preset transportation;
a weather server comprising a second processor configured to output weather information to the center server; and
a terminal device comprising a third processor configured to output, to the center server, a route search request including at least a scheduled departure time, an origin, and a destination,
wherein the first processor is configured to:
acquire the weather information along a route from the origin to the destination from the weather server in a case where the route search request is acquired from the terminal device;
perform the route search in consideration of weather along the route included in the weather information; and
output, to the terminal device, a route search result including at least the scheduled departure time, the origin, the destination, transportation used along the route, a boarding point of the transportation, and an exit point of the transportation.

2. The route search system according to claim 1, wherein the first processor is configured to:
acquire the weather information along the route from the weather server in a case where the route search result includes a route using transportation involving a possibility of getting wet in rain; and
perform a route search again excluding the transportation involving the possibility of getting wet in rain in a case where the weather along the route included in the weather information is rainy; and
output a result of the route search to the terminal device.

3. The route search system according to claim 1, wherein the first processor is configured to:
perform a route search such that a final exit point of the transportation included in the route search result will be an exit point closest to the destination in a case where the weather along the route included in the weather information is rainy; and
output a result of the route search to the terminal device.

4. The route search system according to claim 1, wherein the first processor is configured to:
perform a route search such that a final exit point of the transportation included in the route search result will be a roofed facility in a case where the weather along the route included in the weather information is rainy; and
output a result of the route search to the terminal device.

5. A route search apparatus comprising a processor configured to perform a route search using one or a combination of a plurality types of preset transportation, wherein the processor is further configured to:
acquire weather information along a route from an origin to a destination from a weather server in a case where a route search request including at least a scheduled departure time, the origin, and the destination from a terminal device is acquired;
perform a route search in consideration of weather along the route included in the weather information; and
output, to the terminal device, a route search result including at least the scheduled departure time, the origin, the destination, transportation used along the route, a boarding point of the transportation, and an exit point of the transportation.

6. The route search apparatus according to claim 5, wherein the processor is configured to:
acquire the weather information along a route from the weather server in a case where the route search result includes the route using transportation involving a possibility of getting wet in rain; and
perform a route search again excluding the transportation involving a possibility of getting wet in rain in a case where the weather along the route included in the weather information is rainy; and
output a result of the route search to the terminal device.

7. The route search apparatus according to claim 5, wherein the processor is configured to:
perform a route search such that a final exit point of the transportation included in the route search result will be an exit point closest to the destination in a case where the weather along the route included in the weather information is rainy; and
output a result of the route search to the terminal device.

8. The route search apparatus according to claim 5, wherein the processor is configured to:
perform a route search such that a final exit point of the transportation included in the route search result will be a roofed facility in a case where the weather along the route included in the weather information is rainy; and
output a result of the route search to the terminal device.

9. A non-transitory computer-readable recording medium on which an executable program is recorded, the program causing a processor of a computer to execute:
acquiring weather information along a route from an origin to a destination from a weather server in a case where a route search request including at least a scheduled departure time, the origin, and the destination is acquired from a terminal device;
performing a route search using one or a combination of a plurality types of preset transportation, in consideration of weather along the route included in the weather information; and
outputting, to the terminal device, a route search result including at least the scheduled departure time, the origin, the destination, a transportation used along the route, a boarding point of the transportation, and an exit point of the transportation.

10. The non-transitory computer-readable recording medium according to claim 9, wherein the program causes the processor to execute:
acquiring the weather information along a route from the weather server in a case where the route search result includes the route using transportation involving a possibility of getting wet in rain;
performing, in a case where the weather along the route included in the weather information is rainy, a route search again excluding the transportation involving a possibility of getting wet in rain; and
outputting a result of the route search to the terminal device.

11. The non-transitory computer-readable recording medium according to claim 9, wherein the program causes the processor to execute:
performing, in a case where the weather along the route included in the weather information is rainy, a route search such that a final exit point of the transportation included in the route search result will be an exit point closest to the destination; and
outputting a result of the route search to the terminal device.

12. The non-transitory computer-readable recording medium according to claim 9, wherein the program causes the processor to execute:
performing, in a case where the weather along the route included in the weather information is rainy, a route search such that a final exit point of the transportation included in the route search result will be a roofed facility; and
outputting a result of the route search to the terminal device.
